(19) United States
(12) Patent Application Publication
(10) Pub. No.: US 2006/0286304 A1
(43) Pub. Date: Dec. 21, 2006

(54) Methttod for producing metal conductors on a substrate

(76) Inventors: Markku Leskela, Espoo (FI); Seppo Lindroos, Helsinki (FI); Hanna Uusikartano, Helsinki (FI); Pekka Koivukunnas, Jarvenpaa (FI)

Correspondence Address: OLIFF & BERRIDGE, PLC, P.O. BOX 19928, ALEXANDRIA, VA, 22320, US

(21) Appl. No.: 10/557,174

(22) PCT Filed: May 28, 2004
(86) PCT No.: PCT/FI04/00327

§ 371 Date: Jan. 20, 2006

(30) Foreign Application Priority Data
May 30, 2003 (FI) 20030816

(51) Int. Cl. B05D 5/00; B05D 1/18; B05D 7/00

(52) U.S. Cl. 427/443.1; 427/437; 427/304; 427/421.1; 427/258

(57) ABSTRACT

The invention relates to a method for producing metal conductors, for instance copper conductor patterns as electronic components on a substrate, such as paper. Said method is particularly suitable for producing metal conductors on papers for large scale mass production using printing or like machines. In the method, an electroless deposition is carried out in at least two steps wherein a solution is made of one of the metallic starting material or the reducing agent, or the other one is present in a gas or vapour form, followed by successive application thereof on the substrate.

### FIELD OF THE INVENTION

The present invention relates to a method for producing metal conductors, for instance copper conductor patterns as electronic components on a substrate, such as paper. Said method is particularly suitable for producing metal conductors on paper for large scale mass production using printing or like machines.

### PRIOR ART

In microelectronic industry, semiconducting devices that are increasingly smaller in size and faster, are continuously developed. Metals, typically aluminium but also more recently, due to low resistances thereof, increasingly higher amounts of copper and minor amounts of silver are used for the production of integrated circuits and microchips. Copper is also endowed with other desirable properties, including high thermal stability and low price. Production of copper films and patterns on various substrates is, however, often accompanied with problems, and the methods used are complicated. At present, mainly UV photolithographic methods are used for producing copper film patterns at scales below 200 μm.

Direct printing of a copper pattern on a substrate using an ink-jet printing method has recently been studied intensively due to the following advantages:
the method may be carried out with a simple, inexpensive device that may be controlled readily,
said printing method is safe and has no drawbacks,
printing is carried out directly without etching or complicated surface treatments,
only low amounts of reagents are needed for printing, and the energy consumption thereof being low.

The U.S. Pat. NO. 5,132,248 discloses the use of a colloidal copper suspension for ink-jet printing method, followed by treatment at elevated temperature or laser treatment, and removal of excessive material.

The use of various copper precursors including organic copper compounds is proposed for ink-jet printing method. After printing, however, heating at elevated temperatures must be carried out, the organic moiety of the compound being thus evaporated in the environment. Examples include copper hexenoate described in Hong, C. M., Wagner, S., IEEE Electron Device Lett. 2000, 21, 384.

Metal films may be produced on substrates with the so-called electroless deposition method. Electroless deposition is defined as the controlled autocatalytic formation of a continuous film on a catalytic boundary due to a reaction of a metal salt with a reducing chemical, in a solution. The reaction is normally carried out at the temperature of 30-80° C., and no external power source is required for the reaction. The metal ion and reducing agent are present in the same solution, and, they react at the catalytic boundary, or seed surface, typically comprising palladium or tin. Suitable metals for said electroless deposition are nickel, copper, gold, palladium and silver. In this method, the metal uniformly covers the surface to be treated and also penetrates into cavities and pores, but, however, the method is slow. Complexing agents are used for stabilizing the solution, but said agents also decrease the rate of the reaction.

The U.S. Pat. No. 5,158,604 describes a viscous aqueous solution suitable for electroless deposition, comprising metal ions e.g. copper or nickel, metal complexing agents e.g. EDTA, metal reducing agent e.g. formaldehyde or hypophosphite, and thickening agent e.g. xanthan gum, silica, or carboxymethylcellulose. The solution is applied on a heated catalytic substrate comprising metal or polymer, said substrate being stationary or in form of a moving web, the solution being also preferably preheated before application thereof.

Document WO 00/33625 discloses a method for forming a conductive layer on a polymer substrate wherein ink containing catalytic particulate silver, copper, etc. is printed on a substrate with a lithographic printing method, followed by the immersion of said substrate into a conventional bath for electroless deposition, for providing a conductive layer.

Electroless deposition is a known solution phase method for depositing metal films on catalytic surfaces. As a process, said electroless deposition is too slow, and thus unsuitable for large scale mass production. The reason for this is the fact that increasing of concentrations of the starting compounds in the solution would cause instability of the solution and accodingly, homogeneous reactions would take place. Moreover, the initiation of the deposition of the metal on the substrate requires activation of the substrate surface, which is typically achieved with platinum. Known substractive lithographic processes of the prior art, wherein the desired pattern is etched, are not suitable for mass production. In addition, the methods of the prior art are often expensive, and produce high amounts of wastes.

Accordingly, it is clear that there is an evident need for a method for producing metal conductors, particularly metal conductor patterns on substrates, which method is especially suitable for large scale mass production, and may be carried out with a printing machine or a similar apparatus at high speed. Moreover, the method should be simple, fast and inexpensive.

### OBJECT OF THE INVENTION

The object of the invention is to provide a method for producing a metal conductor on a substrate.

Another object of the invention is to provide a method for producing metal conductors, e.g. copper conductor patterns as electronic components on a substrate.

Still another object of the invention is to provide a method particularly suitable for producing metal conductors on paper for large scale mass production using a printing machine or like apparatus.

Characteristic features of the method of the invention are presented in the claims.

### SUMMARY OF THE INVENTION

Now it has been surprisingly found that the problems and disadvantages associated with the prior art solutions may be eliminated or at least substantially reduced by the method of the invention. In said method, electroless deposition is carried out in at least two steps. Metallic starting material and the reducing agent are incorporated in separate solutions, or one of them is present in gas or vapour form, said solutions or gasses or vapours being then successively sprayed or applied on the substrate to sites where a film is desired.

### DETAILED DESCRIPTION OF THE INVENTION

In the method according to the invention, electroless deposition is carried out in at least two steps. In said electroless deposition, a solution is formed from at least one of the metallic starting material and reducing agent, or one of them is present as gas or vapour, and then they are succesively applied on a substrate. Thus, separate solutions are always made from the metallic starting material and reducing agent, or one of them is present as gas or vapour, said solutions or gases or vapours being successively sprayed or applied on the substrate to sites where a film is desired. As opposed to conventional electroless depositions, starting materials are incorporated in separate solutions or one of them is present as gas or vapour, and therefore the growth of the metal film may be accelerated by increasing the concentrations of the starting materials, without simultaneously causing undesirable homogeneous reactions. In the method according to the invention, at least one of the starting materials is present in a solution, which is sprayed on or the paper or other substrate to sites where a metal film is desired. Said solutions are preferably aqueous solutions, but they may, however, also comprise organic solvents such as alcohols.

Metals suitable for the method are selected from the group consisting of Cr, Mn, Fe, Co, Ni, Cu, Zn, Ga, As, Se, Tc, Ru, Rh, Pd, Ag, Cd, In, Sn, Sb, Te, Re, Os, Ir, Pt, Au, Hg, Tl, Pb, Bi, and alloys thereof. Copper, silver, gold, chromium, iron, cobalt, nickel, palladium and platinum, and the alloys thereof are preferable. Particularly preferable are copper, silver and nickel, in which high conductivity combines with favourable price. The metal is introduced into the aqueous solution suitably as a salt, preferably as a sulphate or chloride. Said metal solution contains said metal salt in a concentration varying between 0.005 M and the concentration corresponding to a saturated solution, preferably from 0.1 to 0.5 M. Said metal solution is preferably an aqueous solution.

Said metal solution also optionally contains one or more complexing compounds preferably selected from the group consisting of EDTA, citric acid, ethylenediamine.

The relative amount of the complexing compound is at least stoichiometric with respect to the metal.

The pH of the metal solution is adjusted if necessary, the suitable pH range depending on the metal used. EDTA complex of copper may be mentioned as an example, for which the lower pH limit is 6, the preferable range being from 12 to 13. Any suitable base, preferably sodium hydroxide, may be used for pH adjustment.

Suitable reducing agents include alkali and alkaline earth metal borohydrides, e.g. NaBH₄ and hypophosphites such as NaH₂PO₂, formaldehyde NCON, hydrazinhydrate N₂H₄, and aminoboranes R₂NHBH₃, where the group R may be an alkyl group, preferably a methyl, ethyl or a propyl group. The reducing agent is preferably used as an aqueous solution.

Moreover in the solutions containing the metal and the reducing agent, surface active agents and agents controlling the surface tension may be used, if necessary, polyethylene glycol and sodium lauryl sulphate being mentioned as examples.

The substrate is stationary, or it is a moving web, and futher, it may comprise paper, board, other fibrous material, polymeric material, or metal coated with a polymer. It is not necessary to catalytically activate the substrate before application.

The number of the starting material solutions, gasses and vapours may be more than one.

In the first step, one of the solutions of the starting materials, that is, either the metal solution or the solution of the reducing agent, is introduced onto the substrate surface using a suitable application method, suitably with conventional printing methods such as gravure, flexo, offset, silk screen, or ink-jet printing method, and preferably with ink-jet printing method to the sites where a pattern is desirably formed, or optionally on the whole surface. In the second step, the other starting material, that is the metal or the reducing agent, is thereafter brought on the surface of the substrate in form of a solution using a suitable application method, suitably with conventional printing methods such as gravure, flexo, offset, silk screen, or ink-jet printing method, and preferably with ink-jet printing, thus either injected to form a pattern, or to cover the whole surface, or optionally vaporized or as a gas. It is particularly preferable to use a digitally controlled ink-jet printing method. The order of application of the starting materials is immaterial, and the application of the starting materials on the substrate may respectively be repeated several times.

Application may be carried out on the substrate using a suitable roll-to-roll printing method or on sheets, and further, the substrate may comprise paper, board, other fibrous material, polymeric material, or metal coated with a polymer. A roll-to-roll printing method is preferably used.

The application is performed at a temperature depending on the process. For instance in copper process, the temperature is from 20 to 200° C., preferably from 20 to 140° C.

The method of the invention has several advantages. The electroless deposition used to form the pattern may be carried out by applying either, or both of the starting components preferably in the form of respective solutions only to those sites where the metal deposition is desired. The reaction of method according to the invention is fast since no stabilizers are needed. With this method, an electrically conducting pattern having a desired form may be produced using an additive method on the substrate to the desired site, and the thickness of the pattern may vary over a wide range. The method may be performed at room temperature, at a normal atmosphere without any protective gasses. The solutions are aqueous and stable at room temperature, and moreover, the starting materials are inexpensive. No waste is produced in the method, as opposed to the etching methods of prior art.

The invention is now illustrated by means of the following examples, without wishing to limit the scope thereof in any way.

### EXAMPLES

### Example 1

### Deposition of Copper on Paper

In the example, a solution of copper sulphate complexed with ethylenediamine-tetracetic acid (EDTA) (0.25 M CuSO₄×5H₂O+0.25 M EDTA) was used as the starting copper material, and sodium borohydride (2,0 M NaBH₄) acted as the reducing agent. The pH of the copper solution was adjusted to basic (pH 12-13) with sodium hydroxide (NaOH) before use. The copper starting material solution and the solution of the reducing agent were applied alternately on the paper at 140° C. in the air. The copper solution was allowed to spread on the paper for about 20 seconds, followed by the addition of the solution of the reducing agent. The paper was kept at 140° C. for about 2 minutes. As a result, a conductive (about 4-20Ω) copper layer was obtained on a filter paper (Whatman) by respectively applying the two solutions three times, in amounts of 100 μl, respectively.

The overall reaction:
2 Cu(EDTA)²⁻+BH₄⁻+4 OH⁻→2 Cu+2H₂+B(OH)₄⁻+2 EDTA⁴⁻

### Example 2

### Deposition of Silver on Paper

In this example, a solution of silver nitrate complexed with ammonia (NH₃) was used as the silver starting material (0.04 M AgNO₃+0.01 NH₃), sodium borohydride (2,0 M NaBH₄) acting as the reducing agent. The pH of the silver solution was 12-13 before use. The silver solution and reducing agent were alternately applied on the paper, at 160° C. in the air. The silver solution was allowed to spread on the paper for about 20 seconds, followed by the addition of the solution of the reducing agent. The paper was kept at 160° C. for about 2 minutes. As a result, a conductive (about 1-10Ω) silver layer was obtained on a filter paper (Whatman) by using a 100 μl application.

The overall reaction:
8[Ag(NH₃)₂]⁺+BH₄⁻+10 OH⁻→8 Ag+BO₃⁻+16 NH₃+7 H₂O

1. Method for producing metal conductors on a substrate, characterized in that an electroless deposition is carried out in said method at least in two steps, wherein a solution is made at least from a metallic starting material or from a reducing agent, or the other one being in gas or a vapour form, followed by the successive application thereof on the substrate.

2. Method according to claim 1, characterized in that the metal of the metal starting material is selected from the group consisting of Cr, Mn, Fe, Co, Ni, Cu, Zn, Ga, As, Se, Tc, Ru, Rh, Pd, Ag, Cd, In, Sn, Sb, Te, Re, Os, Ir, Pt, Au, Hg, Tl, Pb, Bi, and alloys thereof.

3. Method according to claim 1 or 2, characterized in that the metal is copper, silver, gold, chromium, iron, cobalt, nickel, palladium and platinum, and the alloys thereof.

4. Method according to any of claims 1-3, characterized in that the metal is copper, silver or nickel.

5. Method according to any of claims 1-4, characterized in that the metal is incorporated into the metal solution in the form of a salt soluble in water, preferably as a sulphate or chloride, said metal solution containing the metal salt in a concentration varying between 0.005 M and the concentration corresponding to a saturated solution, preferably from 0.1 to 0.5 M.

6. Method according to any of claims 1-5, characterized in that said metal solution also contains one ore more complexing compounds, preferably EDTA, citric acid, or ethylene diamine.

7. Method according to any of claims 1-6, characterized in that said reducing agent is an alkali metal or alkaline earth metal borohydride or hypophosphite, formaldehyde, hydrazinhydrate, or aminoborane R₂NHBH₃, where the group R represents an alkyl group,

8. Method according to any of claims 1-7, characterized in that said reducing agent is sodium borohydride, formaldehyde, sodium hypophosphite, hydrazinhydrate, or aminoborane R₂NHBH₃, where the group R represents a methyl, ethyl or a propyl group, said reducing agent being preferably as an aqueous solution.

9. Method according to any of claims 1-8, characterized in that the substrate is stationary or a moving web comprising paper, board, other fibrous material, polymeric material, or metal coated with a polymer.

10. Method according to any of claims 1-9, characterized in that one of the starting materials is applied as a solution on the surface of the substrate using a printing method to sites where a pattern is desirably formed, or optionally on the whole surface, and when the other starting material is applied as a solution on the surface of the substrate using a printing method, either to form a pattern by injection, or sprayed to cover the whole surface.

11. Method according to claim 10, characterized in that the printing method is a gravure, flexo, offset, silk screen, or ink-jet printing method.

12. Method according to claim 10 or 11, characterized in that said printing method is a ink-jet printing method.

13. Method according to any of the claims 10-12, characterized in that said printing method is a roll-to-roll printing method.

14. Method according to any of the claims 10-13, characterized in that said printing method is a digitally controlled ink-jet printing method.
